(19) United States
(12) Patent Application Publication
(10) Pub. No.: US 2006/0036872 A1
(43) Pub. Date: Feb. 16, 2006

(54) Anti-burglary USB flash drive with press-button type electronic combination lock

(76) Inventor: Kai Hwa Yen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/189,754

(22) Filed: Jul. 27, 2005

(30) Foreign Application Priority Data
Aug. 11, 2004 (CN) 200420084379.0

(51) Int. Cl. H04L 9/00

(52) U.S. Cl. 713/183

(57) ABSTRACT

The objective of the present invention is to provide an anti-burglary USB flash drive with a press-button type electronic combination lock that adopts an IC password circuit without requiring a driver program for achieving the effects of preventing burglary and protecting confidential data stored in the USB flash drive by means of entering a password to a main body of the USB flash drive. The invention allows users to connect a USB flash drive to a computer system and enter a correct password into the main body. Then, a programmable logic IC in the main body of the USB flash drive checks the password, and if the password is correct, then the user is permitted to access the data stored in the USB flash drive. A correct password entered into the main body of a USB flash drive is used to turn on the USB flash drive for the access by the computer system, and such arrangement can achieve the effects of preventing burglary and protecting the confidential information stored in the USB flash drive. Since the main body comes with press buttons for entering a password, therefore the invention is convenient for the use by general computers.

### BACKGROUND OF THE INVENTION

1. Field of the Invention

The present invention relates to a USB flash drive, more particularly to an anti-burglary USB flash drive with a press-button type electronic combination lock.

2. Description of the Related Art

In general, present popular USB flash drives usually use a flash memory for the memory device, and the flash memory has large storage capacity and compact features to go with the standard data transmission USB interface of a computer system, and thus the USB flash drive has become a mainstream of the portable storage medium. The practicability and convenience of the USB flash drive are unquestionable, but the security design still needs further improvements. At present, there are two security designs and one of these designs is the “password type design” that uses software to protect confidential data and allows users to connect a USB flash drive to a computer system and the system will request users to enter a correct password for accessing files and data after detecting the USB flash drive. However, the confidential data stored in the USB flash drive made according to this design may be stolen by hacker programs easily. Further, most designs of the present industrial computers do not have a keyboard, and thus the password type design cannot be used for the industrial computers.

The other design is the “fingerprint type design” that installs a fingerprint recognition chip to the USB flash drive for identifying user's fingerprints. If the inputted fingerprint matches with the one stored in the memory, then the USB flash drive is turned on for accessing files and data. However, the fingerprint type design uses the fingerprint of specific users for the identification; if the fingerprint provided by the user comes from an injured finger or a stained finger, the fingerprint recognition will be affected. As a result, the data in the USB flash drive cannot be accessed thus causing tremendous inconvenience to users. Furthermore, the cost of the fingerprint type of design is very high, which is several times as much as a USB flash drive. Further, both of the aforementioned designs require users to preload a driver program into the computer system for executing the program of identifying the inputted password or fingerprint. Such arrangement may limit its use in different locations or even may be unable to access the data in the USB flash drive, and thus has a drawback on its convenience that is definitely not intended.

In view of the foregoing shortcomings, the inventor of the present invention based years of experience in the related field to conduct extensive research and experiments and finally invented an improved structure.

To make it easier for our examiner to understand the objective of the invention, its structure, innovative features and performance, we use a preferred embodiment together with the attached drawings for the detailed description of the invention.

### SUMMARY OF THE INVENTION

The objective of the present invention is to provide an anti-burglary USB flash drive with a press-button type electronic combination lock that adopts an IC password circuit without requiring a driver program for achieving the effects of preventing burglary and protecting confidential data stored in the USB flash drive by means of entering a password to a main body of the USB flash drive. The invention allows users to connect a USB flash drive to a computer system and enter a correct password into the main body. Then, a programmable logic IC in the main body of the USB flash drive checks the password, and if the password is correct, then the user is permitted to access the data stored in the USB flash drive. A correct password entered into the main body of a USB flash drive is used to turn on the USB flash drive for the access by the computer system, and such arrangement can achieve the effects of preventing burglary and protecting the confidential information stored in the USB flash drive. Since the main body comes with press buttons for entering a password, therefore the invention is convenient for the use by general computers and also very suitable for the industrial computer without a keyboard or an input device.

### BRIEF DESCRIPTION OF THE DRAWINGS

FIG. 1 is an exploded view of the USB flash drive according to the present invention.

FIG. 2 is a perspective view of the USB flash drive according to the present invention.

FIG. 3 is a brief view of the circuits according to the present invention.

### DETAILED DESCRIPTION OF THE INVENTION

The present invention discloses an anti-burglary USB flash drive with a press-button type electronic combination lock which adopts an IC password circuit without requiring a driver program for achieving the effects of preventing burglary and protecting confidential data stored in the USB flash drive by means of entering a password to a main body of the USB flash drive. The invention allows users to connect a USB flash drive to a computer system and enter the correct password into the main body. Then, a programmable logic IC in the main body of the USB flash drive checks the password, and if the password is correct, then the user is permitted to access the data stored in the USB flash drive. A correct password entered into the main body of a USB flash drive is used to turn on the USB flash drive for access by the computer system, and such arrangement can achieve the effects of preventing burglary and protecting the confidential information stored in the USB flash drive. Since the main body comes with press buttons for entering a password, therefore the invention is convenient for the use by general computers and also very suitable for the industrial computer without a keyboard or an input device.

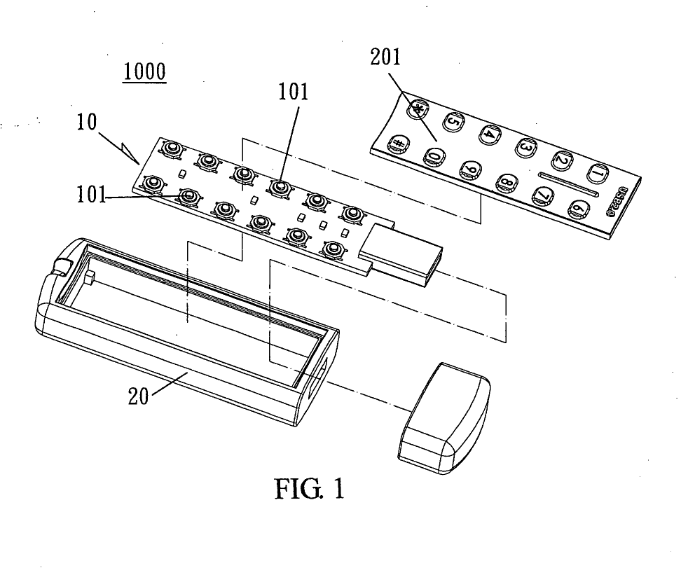

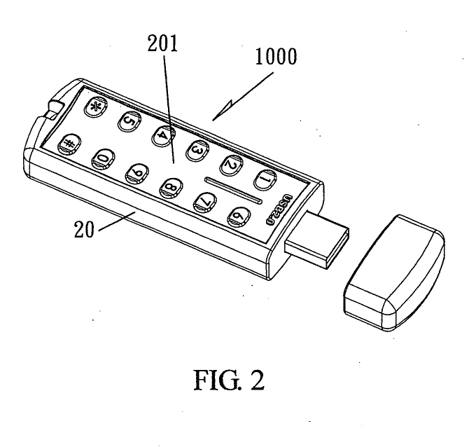

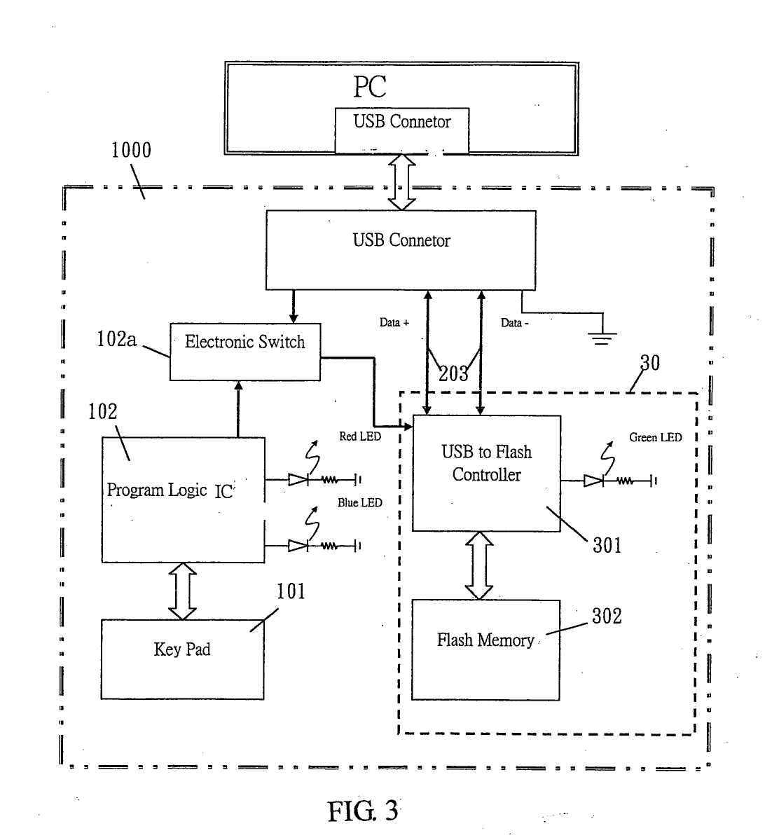

Please refer to FIGS. 1, 2 and 3 for the anti-burglary USB flash drive with a press-button type electronic combination according to the present invention comprising a plurality of numeric functional press keys 101 disposed on a printed circuit board 10, and the printed circuit board 10 being disposed in a housing 20, a numeric pad 201 being disposed on a panel of the housing 20 and having a plurality of numbers corresponding to the press keys 101 on the printed circuit board 10 of the USB flash drive; wherein the numeric functional press keys are for inputting a password, and a programmable logic IC 102 disposed on the printed circuit board 10 of the USB flash drive for identifying a correct password and controlling the open access of data stored in the USB flash drive or detecting a wrong password to deny any access of data stored in the USB flash drive.

In FIGS. 1, 2 and 3, the USB flash drive 1000 is connected to a computer and the computer supplies the power to the USB flash drive 1000. The computer does not need to install a driver program before it can read the input of passwords, but users just need to press the numbers on the numeric pad 201 in order to input the password by pressing the corresponding press keys 101 and an enter key. The programmable logic IC 102 will identify the password; if the password is correct, then the programmable logic IC 102 will send out a signal to use as electronic switch 102a opening the data signed line 203 via controller 301 of memory unit 30 and reading flash memory 302 and allow the computer to access data of the USB flash drive 1000. If the password is incorrect, the programmable logic IC 102 will lock the USB flash drive 1000 to prevent a disclosure of the confidential data.

In view of the description above, the structure of the anti-burglary USB flash drive with a press-button type electronic combination lock according to the present invention can definitely achieve the effects of preventing the hacking of a password and the unintentional disclosure of confidential data.

While the invention has been described by way of example and in terms of a preferred embodiment, it is to be understood that the invention is not limited thereto. To the contrary, it is intended to cover various modifications and similar arrangements and procedures, and the scope of the appended claims therefore should be according to the broadest interpretation so as to encompass all such modifications and similar arrangements and procedures.

What the invention claimed is:

1. An anti-burglary USB flash drive with a press-button type electronic combination lock, comprising:
a plurality of numeric functional press keys, disposed on a printed circuit board and said printed circuit board being disposed in a housing, and a numeric pad being a panel of said housing and having a plurality of numbers corresponding to said numeric functional press keys of said printed circuit board of said USB flash drive; wherein said numeric functional press keys being used for inputting a password, and a programmable logic IC disposed on said printed circuit board of said USB flash drive for identifying a correct password and selectively controlling the access of data stored in the USB flash drive and detecting a wrong password to lock the access of data stored in the USB flash drive; and
by means of connecting said USB flash drive to a computer for supplying power from said computer to said USB flash drive, said computer requiring no driver program for inputting said password and when the number on said numeric pad and an enter key being pressed, said programmable logic IC determining the correctness of said password to selectively send out a signal to use as electronic switch opening data signed line via controller of memory unit and reading flash memory to said USB flash drive to open the access of data stored in said USB flash drive if said password is correct and lock up the access of data stored in said USB flash drive for preventing the disclosure of said confidential data if said password is incorrect.
